(19) United States
(12) Patent Application Publication
(10) Pub. No.: US 2010/0048834 A1
(43) Pub. Date: Feb. 25, 2010

(54) CABLE SHEATHING

(75) Inventors: Oliver Steffen Henze, Damme (DE); Rolf Steinberger, Bissendorf (DE); Ruediger Krech, Diepholz (DE); Nicole Duevel, Damme (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/519,771

(22) PCT Filed: Dec. 12, 2007
(86) PCT No.: PCT/EP07/63789

§ 371 Date: Aug. 7, 2009

(30) Foreign Application Priority Data
Dec. 22, 2006 (EP) 06127092.2

(51) Int. Cl. C08L 75/04; C08G 18/00

(52) U.S. Cl. 525/453; 528/85

(57) ABSTRACT

Cable sheathing on the basis of thermoplastic polyurethane based on the reaction of (a) isocyanates with (b) diols, wherein the diol (b) is based on straight-chain or branched diols (i) having from 16 to 45 carbon atoms in an uninterrupted carbon skeleton.

The invention relates to cable sheathing on the basis of thermoplastic polyurethane based on the reaction of (a) isocyanates with (b) diols, where the diol (b) is based on straight-chain or preferably branched, preferably aliphatic, saturated or unsaturated, preferably saturated, diols (i) having from 16 to 45, preferably from 32 to 44, particularly preferably 36, carbon atoms in an uninterrupted carbon skeleton. The invention further relates to cable sheathing on the basis of thermoplastic polyurethane based on the reaction of (a) isocyanates with (b) diols, where the diol (b) is based on, i.e. comprises, dimer diol as diol (i). In this specification, the term dimer diol includes diols on the basis of dimer fatty acids. The present invention moreover relates to processes for the sheathing of cables, in particular of cables carrying current, via extrusion of thermo-plastic polyurethane, where the inventive thermoplastic polyurethane is used.

The use of thermoplastic polyurethane, hereinafter also termed TPU, as material for the sheathing of cables is well known. TPUs can be selected for this application sector because they have excellent mechanical properties, in particular their outstanding abrasion resistance, and the high elasticity of the material.

A particular requirement for cable sheathing is that the material is to have maximum volume electrical resistance. For this reason, electrical conductors are frequently first sheathed with PVC, EVA, or PE, and only then provided with the highly abrasion-resistant TPU sheath. This double sheathing implies significantly increased cost when comparison is made with a simple sheath structure, and it would therefore be desirable to develop a material which has been optimized not only with respect to mechanical properties but also with respect to sufficient electrical insulation resistance.

It was therefore an object of the present invention to develop a cable sheathing which has outstanding mechanical properties, in particular very low abrasion together with very good elasticity, but moreover also has sufficiently high electrical insulation resistance. In particular, the material should comply with the requirements of leading automobile manufacturers, particularly the LV 112 standard for electrical insulation resistance.

These objects have been achieved via the cable sheathing described in the introduction, particularly for electrical lines on the basis of copper, particularly untreated copper, tinned copper, silvered copper, and/or aluminum.

A feature of the inventive cable sheathing on the basis of TPU is that the use of the hydrophobic diols (i) as diol component for the reaction with the isocyanate (a) permitted combination of the excellent mechanical property profile of TPU with optimized, i.e. high, volume electrical resistance. Another advantage of the inventive cables is that specifically in the use as flat cables, the angles rising during laying of the cables around corners can very easily be fixed via brief heating and adhesive-bonding or welding, by virtue of the thermoplastic material used.

The inventive diols (i) are well known, e.g. from DE-A 195 13 164 and DE-A 43 08 100, page 2, line 5 to line 43, and are commercially available, e.g. in the form of dimer diol, and also as esters based on dimer fatty acid. The production of polyurethanes and also of thermoplastic polyurethanes has also been described, see also Fett/Lipid 101 (1999), No. 11, pp. 418-424, DE-A 44 20 310, and DE-A 195 12 310. This prior art does not, however, give the person skilled in the art any indication of use of appropriate diols for increasing volume electrical resistance in cable sheathing.

Well known dimer diol can preferably be used as diol (i), and therefore as diol (b), and is preferably the reaction product of dimerization of unsaturated fatty alcohols and/or the product of hydrogenation of dimeric fatty acids and/or of hydrogenation of their fatty acid esters. Appropriate products are described in DE 43 08 100 A1, page 2, line 5 to line 43, and their preparation is moreover described in DE 11 98 348, DE 17 68 313, and WO 91/13918, which are also cited in DE 43 08 100.

The dimer diol here preferably has from 16 to 45, preferably from 32 to 44, particularly preferably 36, carbon atoms. If the dimer diol is based on fatty alcohol, this preferably has from 16 to 45, preferably from 32 to 44, particularly preferably 36, carbon atoms. If the dimer diol is based on a dimeric fatty acid, this preferably has from 16 to 45, preferably from 32 to 44, particularly preferably 36, carbon atoms. Preferred fatty acids or fatty acid esters are oleic acid, linoleic acid, linolenic acid, palmitoleic acid, elaidic acid, and/or erucic acid, and/or esters thereof (see DE 43 08 100). Preferably suitable unsaturated fatty alcohols for preparation of the dimer diols are palmitoleyl, oleyl, elaidyl, linolyl, linolenyl, and/or erucyl alcohol. As an alternative, the dimer diol used can comprise the reaction product of dimeric fatty acids with adipic acid, or else a diol selected from 1,4-butanediol, 1,6-hexanediol, and/or polyethylene glycol.

For reaction with the isocyanate, the diol (i) can be used directly, i.e. the thermoplastic polyurethane is based on the reaction of isocyanate with diol (i) as diol (b). As an alternative, a reaction product (ii) of the diol (i) can be used, instead of or together with the diol (i), for reaction with the isocyanate (a). The reaction product (ii) is preferably the reaction product (ii) of the diol (i) with caprolactone or ethylene oxide, particularly preferably caprolactone. The molar mass of the reaction product (ii) is preferably from 800 to 3000 g/mol.

The proportion by weight of the dial (i), based on the total weight of the thermoplastic polyurethane, is preferably from 2 to 25% by weight.

In addition to the diol (i), it is possible to use further, well-known dials. The inventive TPUs are preferably based on the reaction of (a) isocyanate with a component which is reactive toward isocyanates and which comprises polytetrahydrofuran whose molar mass is from 600 to 3000 g/mol, and/or esterdiol whose molar mass is from 600 to 3000 g/mol on the basis of adipic acid, and also with the diol (i) and/or the reaction product (ii), as diol (b). This means that, alongside the inventive diol (i), further diols can be used, these being described as component (b) at a later juncture, preferably polytetrahydrofuran, particularly preferably with molar mass of from 600 to 3000 g/mol, and/or the abovementioned esterdiol, i.e. the ester whose basis is adipic acid and which has two hydroxy groups.

The Shore hardness of the thermoplastic polyurethane is preferably from 70 A to 80 D, preferably from 95 A to 70 D.

It is moreover preferable to use emulsifiers for compatibilization between the non-polar diols (i), in particular the fatty acid derivatives, and the further polar components for production of the TPUs. The thermoplastic polyurethane therefore preferably comprises emulsifiers.

According to the invention, the inventive diols (i) per se or in the form of reaction product (ii) are a constituent of the diol component (b) (dial (b)), this component being reacted with isocyanate to give the TPU.

The inventive cable sheathing, which preferably sheaths an electrical cable on the basis of copper, in particular untreated copper, tinned copper, silvered copper, or aluminum, has the well-known structure. The thickness of the cable sheathing here on the basis of TPU is preferably from 0.01 mm to 2 mm.

It is preferable that the volume resistivity to DIN IEC 60093 of the thermoplastic polyurethane of the inventive cable sheathing after 240 hours of storage in 1% strength aqueous NaCl solution is at least 1*10⁺¹³ Ωcm. It is particularly preferable that the volume resistivity to DIN IEC 60093 of the thermoplastic polyurethane of the inventive cable sheathing in the dry state is at least 1*10⁺¹⁴ Ωcm.

The present invention also provides a process for the sheathing of cables, in particular of cables carrying current, via extrusion of thermoplastic polyurethane, which comprises using the inventive thermoplastic polyurethane.

It is preferable that the diol (i) and/or the reaction product (ii) is/are used to produce a TPU by well-known processes, which is then processed by means of conventional techniques and apparatuses, e.g. via extrusion, to give the cable sheathing. Production of cable sheathing is well known and is described by way of example in
Plastics Extrusion Technology by Friedhelm Hensen, 2nd edition, published 1997 by Hanser Fachbuchverlag (ISBN 3-446-18490-2.);
Polymer Extrusion by Chris Rauwendaal, 4th completely revised edition, published 2006 by Hanser Fachbuchverlag (ISBN 3-446-21774-6);
Extrusion: The Definitive Processing Guide and Handbook by Harold Giles, John Wagner, published 2004 by Noyes Pubn (ISBN 0-8155-1473-5);
Handbuch der Kunststoff—Extrusionstechnik [Plastics handbook—Extrusion technology], Volume 1, Grundlagen [Principles] by Friedhelm Hensen, Werner Knappe, Helmut Potente, published 1989 by Hanser Fachbuchverlag.

It is preferable to produce the thermoplastic polyurethane in the one-shot process and then to process this TPU to give the cable sheathing. The present invention therefore also provides processes for production of the inventive thermoplastic polyurethane via reaction of (a) isocyanates with (b) diols, where the thermoplastic polyurethane is produced in the one-shot process.

Processes for production of TPU are well known. By way of example, the thermoplastic polyurethanes can be produced via reaction of (a) isocyanates with (b) diols, generally compounds which are reactive toward isocyanate and whose molar mass is from 500 to 10000 and, if appropriate, chain extenders whose molar mass is from 50 to 499, if appropriate in the presence of (d) catalysts and/or (e) conventional auxiliaries.

The starting components and processes for production of the preferred TPUs will be described by way of example below. The components (a), (b), and also, if appropriate, (d) and/or (e) usually used during production of the TPUs will be described by way of example below:
a) Organic isocyanates (a) used can comprise well-known aromatic, aliphatic, cycloaliphatic, and/or araliphatic isocyanates, preferably diisocyanates, e.g. diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyidiphenyl diisocyanate, diphenylethane 1,2-diisocyanate, and/or phenylene diisocyanate, tri-, tetra-, penta-, hexa-, hepta-, and/or octamethylene diisocyanate, 2-methylpentamethylene 1,5-diisocyanate, 2-ethylbutylene 1,4-diisocyanate, pentamethylene 1,5-diisocyanate, butylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, and/or dicyclohexylmethane 4,4′-, 2,4′-, and 2,2′-diisocyanate, and preferably diphenylmethane 2,2′-, 2,4′-, and/or 4,4′-diisocyanate (MDI), naphthylene 1,5-diisocyanate (NDI), tolylene 2,4- and/or 2,6-diisocyanate (TDI), hexamethylene diisocyanate, and/or IPDI, in particular 4,4′-MDI.
b) Compounds (b) which can be used and which are reactive toward isocyanate comprise, alongside the inventive diols and/or the reaction products (ii), well-known compounds reactive toward isocyanates, e.g. polyesterols, polyetherols, and/or polycarbonatediols, another term used for all of these being “polyols”, with molar masses of from 500 to 12000 g/mol, preferably from 600 to 6000 g/mol, in particular from 800 to 4000 g/mol, and preferably with average functionality of from 1.8 to 2.3, preferably from 1.9 to 2.2, in particular 2. Chain extenders can moreover be used, e.g. well-known aliphatic, araliphatic, aromatic, and/or cycloaliphatic compounds whose molar mass is from 50 to 499, preferably difunctional compounds, examples being diamines and/or alkanediols having from 2 to carbon atoms in the alkylene radical, in particular 1,4-butanediol, 1,6-hexanediol, and/or di-, tri-, tetra-, penta-, hexa-, hepta-, octa-, nona-, and/or decaalkylene glycols having from 3 to 8 carbon atoms, and preferably corresponding oligo- and/or polypropylene glycols, and mixtures of the chain extenders can also be used here.
d) Suitable catalysts which in particular accelerate the reaction between the NCO groups of the diisocyanates (a) and the hydroxy groups of the structural components (b) are the known and conventional tertiary amines of the prior art, e.g. triethylamine, dimethylcyclohexylamine, N-methylmorpholine, N,N′-dimethylpiperazine, 2-(dimethylaminoethoxy)ethanol, diazabicyclo[2.2.2]octane, and the like, and also in particular organometallic compounds, such as titanic esters, iron compounds, e.g. ferric acetylacetonate, tin compounds, e.g. stannous diacetate, stannous dioctoate, stannous dilaurate, or the dialkyltin salts of aliphatic carboxylic acids, e.g. dibutyltin diacetate, dibutyltin dilaurate, or the like. The amounts usually used of the catalysts are from 0.00001 to 0.1 part by weight per 100 parts by weight of polyhydroxy compound (b).
e) Besides catalysts (d), other materials which may be added to the structural components (a) and (b) are conventional auxiliaries (e). By way of example, mention may be made of surface-active substances, flame retardants, nucleating agents, lubricants, and mold-release agents, dyes and pigments, stabilizers e.g. with respect to hydrolysis, light, heat, or discoloration, inorganic and/or organic fillers, reinforcing agents, and plasticizers. Hydrolysis stabilizers used are preferably oligomeric and/or polymeric aliphatic or aromatic carbodiimides. Stabilizers are preferably added to the inventive TPUs to stabilize them with respect to aging. For the purposes of the present invention, stabilizers are additives which protect a plastic or a plastic mixture from adverse effects of the environment. Examples are primary and secondary antioxidants, hindered amine light stabilizers, UV absorbers, hydrolysis stabilizers, quenchers, and flame retardants. Examples of commercially available stabilizers are given in Plastics Additive Handbook, 5th Edition, H. Zweifel, ed., Hanser Publishers, Munich, 2001 ([1]), pp. 98-136. If the inventive TPU is exposed to thermo-oxidative degradation during its use, antioxidants may be added. It is preferable to use phenolic antioxidants. Examples of phenolic antioxidants are given in Plastics Additive Handbook, 5th edition, H. Zweifel, ed., Hanser Publishers, Munich, 2001, pp. 98-107 and pp. 116-121. Preference is given to phenolic antioxidants whose molar mass is greater than 700 g/mol. An example of a phenolic antioxidant whose use is preferred is pentaerythrityl tetrakis(3-(3,5-bis(1,1-dimethylethyl)-4-hydroxyphenyl)propionate) (Irganox® 1010). The concentrations used of the phenolic antioxidants are generally from 0.1 to 5% by weight, preferably from 0.1 to 2% by weight, in particular from 0.5 to 1.5% by weight, based in each case on the total weight of the TPU. The TPUs are preferably also stabilized with a UV absorber. UV absorbers are molecules which absorb high-energy UV light and dissipate the energy. Familiar UV absorbers used in industry come, by way of example, from the group of the cinnamic esters, the diphenylcyanoacrylates, the formamidines, the benzylidenemalonates, the diarylbutadienes, the triazines, and the benzotriazoles. Examples of commercially available UV absorbers are found in Plastics Additives Handbook, 5th edition, H. Zweifel, ed., Hanser Publishers, Munich, 2001, pp. 116-122. In one preferred embodiment, the UV absorbers have a number-average molar mass greater than 300 g/mol, in particular greater than 390 g/mol. The molar mass of the UV absorbers whose use is preferred should moreover not be greater than 5000 g/mol, particularly preferably not greater than 2000 g/mol. Particularly suitable UV absorbers are the benzotriazoles group. Examples of particularly suitable benzotriazoles are Tinuvin® 213, Tinuvin® 328, Tinuvin® 571, and Tinuvin® 384, and Eversorb® 82. The amounts preferably added of the UV absorbers are from 0.01 to 5% by weight, based on the total weight of TPU, particularly preferably from 0.1 to 2.0% by weight, in particular from 0.2 to 0.5% by weight, based in each case on the total weight of the TPU. The UV stabilizer system described above, based on an antioxidant and a UV absorber, is often still not sufficient to ensure that the inventive TPU has good resistance to the damaging effect of UV radiation. In this case, a hindered amine light stabilizer (HALS) may be added to component (e) of the inventive TPU, preferably in addition to the antioxidant and to the UV absorber. The activity of HALS compounds is based on their ability to form nitroxyl radicals which intervene in the mechanism of oxidation of polymers. HALS are highly efficient UV stabilizers for most polymers. HALS compounds are well known and are available commercially. Examples of commercially available HALS stabilizers are found in Plastics Additive Handbook, 5th edition, H. Zweifel, Hanser Publishers, Munich, 2001, pp. 123-136. Preferred hindered amine light stabilizers are those whose number-average molar mass is greater than 500 g/mol. The molar mass of the preferred HALS compounds should moreover preferably not be greater than 10000 g/mol, particularly preferably not greater than 5000 g/mol. Particularly preferred hindered amine light stabilizers are bis(1,2,2,6,6-pentamethylpiperidyl) sebacate (Tinuvin® 765, Ciba Spezialitätenchemie AG) and the condensate of 1-hydroxyethyl-2,2,6,6-tetramethyl-4-hydroxypiperidine and succinic acid (Tinuvin® 622). Particular preference is given to the condensate of 1-hydroxyethyl-2,2,6,6-tetramethyl-4-hydroxypiperidine and succinic acid (Tinuvin® 622) if the titanium content of the product is <150 ppm, preferably <50 ppm, in particular <10 ppm. HALS compounds are preferably used at a concentration of from 0.01 to 5% by weight, particularly preferably from 0.1 to 1% by weight, in particular from 0.15 to 0.3% by weight, based in each case on the total weight of the TPU. One particularly preferred UV stabilizer system comprises a mixture composed of a phenolic stabilizer, of a benzotriazole, and of a HALS compound, in the preferred amounts described above.

Further information concerning the abovementioned auxiliaries and additives can be found in the technical literature, e.g. from Plastics Additive Handbook, 5th edition, H. Zweifel, ed., Hanser Publishers, Munich, 2001. All of the molar masses mentioned in this specification have the unit [g/mol].

To adjust hardness of the TPUs, the molar ratios of the structural components comprising higher-molar-mass diols and the chain extenders may be varied relatively widely. Molar ratios which have proven successful between higher-molar-mass diol and the entire amount of chain extenders to be used are from 10:1 to 1:10, in particular from 1:1 to 1:4, the hardness of the TPUs rising as content of chain extender increases.

The reaction may take place at conventional indices, preferably at an index of from 950 to 1050, particularly preferably at an index of from 970 to 1010, in particular from 980 to 995. The index is defined via the molar ratio of the total number of isocyanate groups used during the reaction in component (a) to the groups reactive toward isocyanates, i.e. the active hydrogen atoms, in component (b). If the index is 1000, there is one active hydrogen atom, i.e. one function reactive toward isocyanates, in component (b) for each isocyanate group in component (a). If the index is above 1000, there are more isocyanate groups present than OH groups. The TPUs may be prepared by the known processes continuously, for example using reactive extruders or the belt process by the one-shot method or prepolymer method, or batchwise by the known prepolymer process. In these processes, components (a), (b), and, if appropriate, (d), and/or (e) to be reacted are mixed with one another in succession or simultaneously, whereupon the reaction begins immediately. In the extruder process, structural components (a), (b), and also, if appropriate, (d), and/or (e) are introduced, individually or as a mixture, into the extruder, and reacted, e.g. at temperatures of from 100 to 280° C., preferably from 140 to 250° C., and the resultant TPU is extruded, cooled, and pelletized.

Preference is moreover given to TPUs according to WO 03/014179, where, as in the present invention, the diol (i) and/or the reaction product (ii) is/are used as compound (b) reactive toward isocyanates, preferably together with further compounds (b) mentioned in WO 03/014179. The descriptions below as far as the examples relate to these particularly preferred TPUs. These particularly preferred TPUs are preferably obtainable via reaction of (a) isocyanates with the inventive diol (i) and/or with the reaction product (ii), (b1) polyesterdiols whose melting point is greater than 150° C., (b2) polyetherdiols and/or polyesterdiols, each of whose melting points is smaller than 150° C. and each of whose molar masses is from 501 to 8000 g/mol, and also, if appropriate, (c) diols whose molar mass is from 62 to 500 g/mol. Particular preference is given here to thermoplastic polyurethanes in which the molar ratio of the diols (c) whose molar mass is from 62 g/mol to 500 g/mol to component (b2) is smaller than 0.2, particularly preferably from 0.1 to 0.01.

The expression “melting point” in this specification means the maximum of the melting peak of a heating curve measured by a commercially available DSC device (e.g. Perkin-Elmer DSC 7).

The molar masses stated in this specification are number-average molar masses in [g/mol].

In a preferred method of producing these particularly preferred thermoplastic polyurethanes, a preferably high-molar-mass, preferably semicrystalline, thermoplastic polyester can be reacted with a diol (c), and then the reaction product from this step (x) comprising (b1) polyesterdiol whose melting point is greater than 150° C., and also, if appropriate, (c) diol together with (b2) polyetherdiols and/or polyesterdiols each of whose melting points is smaller than 150° C., and each of whose molar masses is from 501 to 8000 g/mol, and also with the inventive diol (i) and/or the reaction product (ii) and, if appropriate, with further (c) diols whose molar mass is from 62 to 500 g/mol, can be reacted with (a) isocyanate, if appropriate in the presence of (d) catalysts, and/or (e) auxiliaries.

The molar ratio of the diols (c) whose molar mass is from 62 to 500 g/mol to component (b2) in the second reaction is preferably smaller than 0.2, preferably from 0.1 to 0.01.

While the first step (x) provides the hard phases for the final product by virtue of the polyester used in step (x), use of component (b2) in step (xx) constructs the soft phases. The preferred technical teaching consists in melting, preferably in a reactive extruder, polyesters having a well-developed hard-phase structure which crystallizes well, and first degrading these with a low-molar-mass diol to give shorter polyesters having free hydroxy end groups. The original high crystallization tendency of the polyester is retained here and can then be utilized for a fast reaction to obtain TPU with the advantageous properties, these being high tensile strength values, low abrasion values, and high heat resistance values due to the high and narrow melting range, and low compression-set values. The preferred process therefore preferably uses low-molar-mass diols (c) to degrade high-molar-mass, semicrystalline, thermoplastic polyesters under suitable conditions in a short reaction time to give polyesterdiols (b1) which crystallize rapidly and which in their turn are then incorporated with other polyesterdiols and/or polyetherdiols and diisocyanates into high-molar-mass polymer chains.

The molar mass of the thermoplastic polyester used here, i.e. prior to the reaction (x) with the diol (c) is preferably from 15000 g/mol to 40000 g/mol, its melting point at this stage preferably being greater than 160° C., particularly preferably from 170° C. to 260° C.

The starting material used, i.e. the polyester which in step (x), preferably in the molten state, particularly preferably at a temperature of from 230° C. to 280° C., is reacted with the diol(s) (c), preferably for a period of from 0.1 min to 4 min, particularly preferably from 0.3 min to 1 min, can comprise well-known, preferably high-molar-mass, preferably semicrystalline, thermoplastic polyesters, for example in pelletized form. Suitable polyesters are based by way of example on aliphatic, cycloaliphatic, araliphatic, and/or aromatic dicarboxylic acids, e.g. lactic acid and/or terephthalic acid, and also on aliphatic, cycloaliphatic, araliphatic, and/or aromatic dialcohols, e.g. 1,2-ethanediol, 1,4-butanediol, and/or 1,6-hexanediol.

Polyesters particularly preferably used are: poly-L-lactic acid and/or polyalkylene terephthalate, e.g. polyethylene terephthalate, polypropylene terephthalate, polybutylene terephthalate, and in particular polybutylene terephthalate.

The preparation of these esters from the starting materials mentioned is well known to the person skilled in the art and has been widely described. Suitable polyesters are moreover commercially available.

The thermoplastic polyesters are preferably melted at a temperature of from 180° C. to 270° C. The reaction (x) with the diol (c) is preferably carried out at a temperature of from 230° C. to 280° C., preferably from 240° C. to 280° C.

The diol (c) used in step (x) for the reaction with the thermoplastic polyester and, if appropriate, in step (xx) and comprise well-known diols whose molar mass is from 62 to 500 g/mol, e.g. the diols mentioned below, e.g. ethylene glycol, 1,3-propanediol, 1,4-butanediol, 1,5-pentanediol, 1,6-hexanediol, heptanediol, octanediol, and preferably 1,4-butanediol and/or 1,2-ethanediol.

The ratio by weight of the thermoplastic polyester to the diol (c) in step (x) is usually from 100:1.0 to 100:10, preferably from 100:1.5 to 100:8.0.

The reaction of the thermoplastic polyester with the diol (c) in reaction step (x) is preferably carried out in the presence of conventional catalysts, e.g. those described below. Catalysts on the basis of metals are preferably used for this reaction. The reaction in step (x) is preferably carried out in the presence of from 0.1 to 2% by weight of catalyst, based on the weight of the diol (c). The reaction is advantageous in the presence of these catalysts, the aim being to permit conduct of the reaction in the reactor in the short residence time available, for example in the reactive extruder.

Examples of catalysts that can be used for this reaction step (x) are: tetrabutyl orthotitanate and/or stannous dioctoate, preferably stannous dioctoate.

The molar mass of the polyesterdiol (b1) as reaction product from (x) is preferably from 1000 to 5000 g/mol. The melting point of the polyesterdiol as reaction product from (x) is preferably from 150° C. to 260° C., in particular from 165° C. to 245° C., i.e. the reaction product of the thermoplastic polyester with the diol (c) in step (x) comprises compounds with the melting point mentioned, these being used in the subsequent step (xx).

By virtue of the reaction of the thermoplastic polyester with the diol (c) in step (x), the polymer chain of the polyester is cleaved via transesterification by virtue of the diol (c). The reaction product of the TPU therefore has free hydroxy end groups and is preferably further processed in the further step (xx) to give the actual product, the TPU.

The reaction of the reaction product from step (x) in step (xx) preferably takes place via addition of a) isocyanate (a), and also (b2) polyetherdiols and/or polyesterdiols, each of whose melting points is smaller than 150° C. and each of whose molar masses is from 501 to 8000 g/mol, and also, if appropriate, further (c) diols whose molar mass is from 62 to 500 g/mol, (d) catalysts, and/or (e) auxiliaries to the reaction product from (x). The reaction of the reaction product with the isocyanate takes place by way of the hydroxy end groups produced in step (x). The reaction in step (xx) preferably takes place at a temperature of from 190° C. to 250° C., preferably for a period of from 0.5 to 5 min, particularly preferably from 0.5 to 2 min, preferably in a reactive extruder, which is particularly preferably the same as the reactive extruder in which step (x) has also been carried out. By way of example, the reaction of step (x) can take place in the first barrel sections of a conventional reactive extruder, and the corresponding reaction of step (xx) can be carried out at a subsequent point, i.e. in subsequent barrel sections, after addition of components (a) and (b2). By way of example, the first 30-50% of the length of the reactive extruder can be used for step (x), and the remaining 50-70% for step (xx).

The reaction in step (xx) preferably takes place with an excess of the isocyanate groups with respect to the groups reactive toward isocyanates. The ratio of the isocyanate groups to the hydroxy groups in the reaction (xx) is preferably from 1:1 to 1.2:1, particularly preferably from 1.02:1 to 1.2:1.

It is preferable to carry out the reactions (x) and (xx) in a well-known reactive extruder. These reactive extruders are described by way of example in the company publications of Werner & Pfleiderer or in DE-A 23 02 564.

The preferred process is preferably carried out as follows: at least one thermoplastic polyester, e.g. polybutylene terephthalate, is fed into the first barrel section of a reactive extruder and melted at temperatures which are preferably from 180° C. to 270° C., preferably from 240° C. to 270° C., and a diol (c), e.g. butanediol, and preferably a transesterification catalyst, is added into a subsequent barrel section, and at temperatures of from 240° C. to 280° C. the polyester is degraded by the diol (c) to give polyester oligomers having hydroxy end groups and molar masses of from 1000 to 5000 g/mol, and in a subsequent barrel section isocyanate (a) and (b2) compounds which are reactive toward isocyanate and whose molar mass is from 501 to 8000 g/mol, and also, if appropriate, (c) diols whose molar mass is from 62 to 500, (d) catalysts, and/or (e) auxiliaries are metered in, and then, at temperatures of from 190° C. to 250° C., the preferred thermoplastic polyurethanes are constructed.

It is preferable that in step (xx), except for the diols (c) which are comprised within the reaction product (x) and whose molar mass is from 62 to 500, no diols (c) whose molar mass is from 62 to 500 are introduced.

In the region in which the thermoplastic polyester is melted, the reactive extruder preferably has neutral and/or backward-conveying kneading blocks and backward-conveying elements, and in the region in which the thermoplastic polyester is reacted with the diol it preferably has screw mixing elements, toothed disks, and/or toothed mixing elements in combination with back-conveying elements.

After the reactive extruder, the clear melt is usually introduced by means of a gear pump to underwater pelletization and pelletized.

The particularly preferred thermoplastic polyurethanes exhibit optically clear, single-phase melts, which solidify rapidly and, as a consequence of the semicrystalline polyester hard phase, form moldings which are slightly opaque to non-transparent white. The rapid solidification is a decisive advantage over known formulations and production processes for thermoplastic polyurethanes. The rapid solidification is so pronounced that even products whose hardness values are from 50 to 60 Shore A can be processed by injection molding with cycle times smaller than 35 s. In extrusion, too, for example in blown-film production, absolutely none of the problems typical of TPU arise, examples being sticking or blocking of the films or bubbles.

The proportion of the thermoplastic polyester in the final product, i.e. in the thermoplastic polyurethane, is preferably from 5 to 75% by weight. The preferred thermoplastic polyurethanes are particularly preferably products of the reaction of a mixture comprising from 10 to 70% by weight of the reaction product from (x), from 10 to 80% by weight of (b2), and from 10 to 20% by weight of (a), the weight data given being based on the total weight of the mixture comprising (a), (b2), (d), (e), and the reaction product from (x).

1-19. (canceled)

20. A cable sheathing comprising a thermoplastic polyurethane based on the reaction of (a) isocyanates with (b) diols, wherein
the diol (b) is based on straight-chain or branched diols (i) having from 16 to 45 carbon atoms in an uninterrupted carbon skeleton and the diol (b) is the reaction product (ii) of the diol (i) with caprolactone and/or ethylene oxide,
or the diol (b) is based on a dimer diol as diol (i) and the dimer diol is the reaction product of dimeric fatty acids with adipic acid, or a diol selected from 1,4-butanediol, 1,6-hexanediol, and/or polyethylene glycol,
or the diol (b) is based on a dimer diol as diol (i), and the dimer diol is the reaction product of dimerization of unsaturated fatty alcohols and the fatty alcohol has from 32 to 44 carbon atoms and/or the product of hydrogenation of dimeric fatty acids and/or of hydrogenation of their fatty acid esters and the fatty acid has from 16 to 45 carbon atoms.

21. The cable sheathing according to claim 20, wherein the molar mass of the reaction product (ii) is from 600 to 3000 g/mol.

22. The cable sheathing according to claim 20, wherein the thermoplastic polyurethane is based on the reaction of isocyanate with diol (i) as diol (b).

23. The cable sheathing according to claim 20, wherein the proportion by weight of the diol (i), based on the total weight of the thermoplastic polyurethane, is from 2 to 25% by weight.

24. The cable sheathing according to claim 20, wherein the thermoplastic polyurethane is based on the reaction of (a) isocyanate with a component which is reactive toward isocyanates and which comprises esterdiol whose molar mass is from 600 to 3000 g/mol on the basis of adipic acid, and also with the diol (i) and/or the reaction product (ii), as diol (b).

25. The cable sheathing according to claim 20, wherein the Shore hardness of the thermoplastic polyurethane is from 70 A to 80 D, preferably from 95 A to 70 D.

26. The cable sheathing according to claim 20, wherein the thermoplastic polyurethane comprises emulsifiers.

27. The cable sheathing according to claim 20, wherein the volume resistivity to DIN IEC 60093 of the thermoplastic polyurethane after 240 hours of storage in 1% strength aqueous NaCl solution is at least 1*10⁺¹³ Ωcm.

28. The cable sheathing according to claim 20, wherein the volume resistivity to DIN IEC 60093 of the thermoplastic polyurethane in the dry state is at least 1*10⁺⁻¹⁴ Ωcm.

29. A process for the sheathing of cables carrying current, via extrusion of thermoplastic polyurethane, which comprises using a thermoplastic polyurethane according to claim 20.

30. The process according to claim 29, wherein the thermoplastic polyurethane is produced in the one-shot process and then is processed to produce the cable sheathing.

31. A process for the production of thermoplastic polyurethane according to claim 20 via reaction of (a) isocyanates with (b) diols, which comprises producing the thermoplastic polyurethane in the one-shot process.

32. The process according to claim 31, wherein the thermoplastic polyurethane is obtained via reaction of (a) isocyanates with straight-chain or branched diols (i) having from 16 to 45 carbon atoms in an uninterrupted carbon skeleton and/or with the reaction product (ii) of the diol (i) with caprolactone and/or ethylene oxide, or the diol (b) is based on a dimer diol as diol (i) and the dimer diol is the reaction product of dimeric fatty acids with adipic acid, or a diol selected from 1-4 butanediol, 1,6-hexanediol, and/or polyethylene glycol, or the diol (b) is based on a dimer diol as diol (i), and the dimer diol is the reaction product of dimerization of unsaturated fatty alcohols and the fatty alcohol has from 32 to 44 carbon atoms and/or the product of hydrogenation of dimeric fatty acids and/or hydrogenation of their fatty acid esters and the fatty acid has from 16 to 45 carbon atoms, (b1) polyesterdiols whose melting point is greater than 150° C., (b2) polyetherdiols and/or polyesterdiols, each of whose melting points is smaller than 150° C. and each of whose molar masses is from 501 to 8000 g/mol, and also, optionally, (c) diols whose molar mass is from 62 to 500 g/mol.
